(19) United States
(12) Patent Application Publication
(10) Pub. No.: US 2003/0092196 A1
(43) Pub. Date: May 15, 2003

(54) Concentration module and method for on-site concentration of trace contaminants from a sample of a liquide for analytical analysis

(76) Inventor: Harmesh K. Saini, Santa Clara, CA (US)

Correspondence Address: Pauley Petersen Kinne & Erickson, Suite 365, 2800 W. Higgins Road, Hoffman Estates, IL, 60195, US

(21) Appl. No.: 10/242,955

(22) Filed: Sep. 13, 2002

Related U.S. Application Data
(60) Provisional application No. 60/332,810, filed on Nov. 14, 2001.

(51) Int. Cl. G01N 1/18

(52) U.S. Cl. 436/177; 436/178; 422/69; 422/100; 422/103

(57) ABSTRACT

A concentration module for concentrating contaminants in a matrix at the site where the matrix is being used. The modules have one or more concentration columns. Each concentration column is packed with the appropriate functional ion-exchange polymer for capturing the desired contaminants, a connector to connect to a source of the matrix, a distributor to connect the connector to the input side of each concentration column, output tubing connected to the output side of each concentration column and a housing for enclosing and supporting each concentration columns, the distributor and the output tubing. A method for concentrating trace contaminants in a matrix for analysis by an analytical instrument while minimizing any contamination of the concentrated trace contaminants comprises the steps of transporting a concentration column to a site where the matrix is being used, the sample concentration column being packed with a functional polymer to capture the trace contaminants in the matrix, connecting the sample concentration column to a site source of the matrix and passing a sample volume of the matrix through the sample concentration column, where said sample volume is greater than a calibration volume used to calibrate the analytical instrument.

### CROSS REFERENCE TO RELATED APPLICATION

This application claims the benefit of U.S. Provisional Application No. 60/332,810, filed 14 Nov. 2001.

### FIELD OF THE INVENTION

The present invention relates to a method and a concentration module for collecting on site a concentrated sample of one or more trace contaminants in a matrix while that matrix is being used whereby the concentrated sample allows for the detection and quantification of very low levels of each concentrated trace contaminant by present state of the art equipment.

### DESCRIPTION OF THE RELATED ART

Many matrices are used in various manufacturing processes of electronic circuitry in the semiconductor industry. As described herein, a matrix is a liquid solution or suspension. Example of a matrix are ultra pure water (UPW), deionized water, steam condensate, ion exchange purified water, distilled water, water for injection (WFI), polishing slurries, processing baths, used rinse waters, reclaimed water and recycled water. A matrix may also be diluted or concentrated acids, bases, oxidants, reductants, solvents (such as alcohol, esters, ethers, glycol, ketones, amides, amines, sulfones, sulfoxides, or their mixtures), rinses, photoresists, strippers and developers.

Monitoring the purity of these matrices is of immense importance for producing reliable devices with high yield. The continuous decrease in the geometry of devices required increased control of the contaminants in a matrix, especially those that directly come in contact with the micro electronic circuitry during device fabrication. Various methods and devices have been used to collect and deliver samples of these matrices to the laboratory for analytical analysis of trace contaminants.

Analysis of ultra trace contaminants in a matrix has always being a challenge, because the matrix effect has a pronounced effect on the quantification of these trace contaminants. In the semiconductor industry, the ever-shrinking geometry of the microchip imposes tighter specification for high purity matrixes poses an ever-increasing challenge to the analytical laboratory.

Among all the matrices used in the semiconductor industry, water is the most abundant that directly comes into contact with devices. This led to the need of producing huge amounts of extra ultra-pure-water (UPW) which complied with stringent specifications. To ensure the supply of high quality UPW, samples of the UPW are analyzed to ensure that the UPW is within the required specifications. This qualitative and quantitative measurement of ultra trace levels of ionic contaminates (cationic or anionic) in UPW has become an analytical challenge. An ion chromatograph is the most widely used analytical instrument to measure ionic contaminants in the UPW.

The present method of collecting and evaluating matrices for impurities will be described using the matrix of ultra pure water. For the routine monitoring of water systems, ultra pure water samples are collected under protected clean environment in the pre-cleaned containers from various sites. Currently, the sample volume collected is in the range from 10 ml to 500 ml, but can be larger if multiple tests are needed. The containers, with the samples, are delivered to the laboratory for measurements of the ionic contaminants by ion chromatography. The current detection limits via normal ion chromatography are in the range of 5-10 ppt for ionic contaminants (6 cations and 7 anions) in ultra pure water.

Present ion chromatograph systems use a sampling pump for offline concentration of the sample onto a concentration column on the ion chromatograph. Ion chromatograph systems have interchangeable concentration columns where each concentration column is designed to extract and capture specific trace contaminants from the sample. For example, for ultra pure water, there is one concentration column packed with a functional ion-exchange polymer for acquiring the seven anions and another concentration column packed with a functional ion-exchange polymer for acquiring the six cations. Before evaluating a sample, commonly 30 ml of a standard is run through the ion chromatograph for the contaminant (here for either the seven anions or the six cations) being evaluated to calibrate the ion chromatograph. These standards are available from manufacturers of ion chromatographs or are made by the analytical laboratory that uses the ion chromatograph.

After the ion chromatograph is calibrated, 30 ml of the sample of the UPW is pumped through the concentration column at a rate of 2-3 ml per minute. This process takes approximately 10-15 minutes. During this time, the sample is in an open bottle exposed to air, which can contaminate the sample. Even where the sample is placed in a clean room or HEPA-filtered mini-environment, many airborne molecular contaminants such as ammonia, chloride, nitrate and nitrite can pass through the environment's filters and be adsorbed into the sample, which will affect the detection limit and reliability of the analysis.

Next, an eluent for the specific contaminant (in this example the seven anions or the six cations) being evaluated is back-flushed through the concentration column. The eluent carries the contaminant (in this example the seven anions or the six cations) out of the concentration column into a separation column of the ion chromatograph. This process cleans the concentration column such that the concentration column can be reused. The separator column separates the contaminant from the eluent and further separates the anions from each other or the cations from each other. The ion chromatograph detects the contaminant and provides a value for the concentration of the contaminant (in this example for each of the seven anions or the six cations in pptw/ml or in ng/ml) in the 30-ml sample tested.

Where the volume of the sample tested is different than the volume of the standard used to calibrate the ion chromatograph the resulting concentration of the contaminant provided by the ion chromatograph must be adjusted by dividing the acquired concentration level by a correction factor. The correction factor is equal to the sample volume passed through the concentration column divide by the calibration volume used to calibrate the equipment. For example, where the volume of the sample passed through the concentration column was 120 ml (which would take 40 minutes at 3 ml per minute) and the calibration volume was 30 ml, then the resulting concentration of the contaminant must be divided by 4 to obtain the correct concentration of the contaminant in the sample.

Balazs Laboratory published guidelines of 20 ppt for anions and cations in UPW. However, it is usually recommended that the detection limit for the analysis be at least 10 times lower than the specification to allow a very reliable assessment of whether the sample is in specification. Thus, the detection limit for UPW is 2 ppt.

Other organizations also have specifications for UPW. For example, the Semiconductor Industry Association and the International Technology Roadmap for Semiconductors have a specification for UPW of less than 20 ppt for each anion, cation and metal through year 2003. Further, there are present indications that these specifications may be lowered to less than 10 ppt in the future. This requires a present detection level of less than 2 ppt and possibly in the future of less than 1 ppt for each anion, cation and metal in UPW.

ASTM D5 127-99“Standard Guide for UPW used in Electronics and Semiconductor industry” has specifications for Type E 1.2 water, water used for leading edge semiconductors. Specifications include 20 ppt for anions and cations, and specifically 50 ppt for ammonium, 2 ppt for Ca, and 5 ppt for Potassium and Sodium. This requires a detection level as low as 0.2 ppt for Ca.

Since current detection limits via normal ion chromatography are in the range of 5 to 10 ppt for cations and anions in ultra pure water, the ion chromatograph alone is not meeting the recommended detection limits. To effectively lower the detection limits of the ion chromatograph, a common practice is to concentrate a larger volume of the sample than the volume of the calibrating sample to obtain a correction factor that effectively lowers the detection level of the ion chromatograph.

To reliably measure the contaminants at part-per-trillion level in UPW using a large sample volume to lower the detection limits is not only complicated but also laborious and time consuming. The biggest challenge is to maintain the integrity of the samples, starting from sampling through analysis.

First, UPW is a strong absorption media for airborne water-soluble contaminants so samples should not be exposed to air at any stage during sampling, transportation, concentration or analysis.

Second, the cleanliness of the sampling containers is very important and a huge amount of time and money is spent to clean these sampling containers.

Third, the time the sample is allowed to sit in the sampling container before being analyzed can also effect the analysis outcome. It has been reported in many publications that the cleanest sample containers can leach out some undesirable contaminants.

Fourth, during the offline concentration on the concentration column of the ion chromatograph, the sample is pushed through a concentration column with pumps and switching valves, which can cause contamination of the sample.

### SUMMARY OF THE INVENTION

Accordingly, it is an object of the present invention to provide the capability for concentrating trace contaminants from matrices for analytical analysis where the risk of contamination is either eliminated or minimized.

It is another object of the invention to provide a concentration module for obtaining a concentrated sample of contaminants from a matrix at the location where and while that matrix is being used.

It is another object of the invention to provide a method of collecting a concentrated sample of a contaminant from a matrix at the location where and while that matrix is being used.

It is another object of the invention to provide a concentrated sample of a contaminant in a concentration column that is compatible with the ion chromatograph such that the concentrated sample in the concentration column may be processed and analyzed by the ion chromatograph.

It is another object of the invention to provide a method and concentration module for enhancing the detection of sub ppt of a contaminant in a matrix.

Briefly, the concentration module consists of one or more concentration columns where each concentration column is packed with the appropriate functional ion-exchange polymer for capturing a desired contaminant. An adapter is provided to connect the concentration module to a source of the matrix that is to be sampled. An input distributor connects the adapter to an input side of each concentration column for distributing the matrix to each concentration column. Identifiable output tubing is connected to the output side of each concentration column for releasing the matrix from the concentration column after the matrix has passed through the functional ion-exchange polymer in the concentration column. A housing is provided for enclosing and supporting the concentration columns, the input distributor and output tubing. The method consists of connecting the concentration module to a source of the matrix to be analyzed and then sampling the matrix.

Concentrating matrix contaminants in one or more concentration columns contained within the concentration module where each concentration column is packed with a functional ion-exchange polymer to absorb one or more contaminants from the matrix. The volume and time that the matrix flows through each concentration column is monitored and recorded. The concentration columns are disconnected from the source of the matrix when sampling is completed. Each concentration module is analyzed to identify and obtain a resultant concentration of each detected contaminant. Factoring the resultant concentration by a factor equal to the volume of the calibration standard divided by the sample volume of the matrix that flowed through the concentration column to obtain the actual concentration of the measured contaminant in the original matrix sampled.

An advantage of the concentration module and method of the present invention is that the concentrated samples are never exposed to air, thereby eliminating the risk of air contamination.

Another advantage of the concentration module and method of the present invention is that there is no need for the use of an expensive protected clean environment during the original sampling.

Another advantage of the concentration module and method of the present invention is that contaminants from the bulk matrix are concentrated directly onto the ion-exchange polymer in the concentration column thereby eliminating the need of cleaned sampling containers.

Another advantage of the concentration module and method of the present invention is that since no sampling containers are used, the problem of contamination from the leaching of contaminants from the container is eliminated.

Another advantage of the concentration module and method of the present invention is that the contaminant of interest is physically adsorbed on the ion-exchange sites of the polymer such that there are no chemical changes to the contaminant, thereby maintaining the integrity of the contaminant.

Another advantage of the concentration module and method of the present invention is that no longer is it required to transport large volumes of matrix to the laboratory, thereby saving money, time and the elimination of the risk of contamination during shipping.

Another advantage of the concentration module and method of the present invention is that the sample of the matrix is concentrated online, thereby eliminating the possibility of contamination associated with the concentration process using the concentration column of the ion chromatograph.

Another advantage of the concentration module and method of the present invention is that detection limits will depend only upon the amount of sample concentrated, thereby eliminating the limitation of the detection limit of the ion chromatograph.

Another advantage of the concentration module and method of the present invention is that the concentration module can be reused unless physically broken or misused.

Finally another advantage of the concentration module and method of the present invention is that the concentration module will be used for real-time on-line concentration over several hours, thereby eliminating false reading due to a short-term increase in the amount of contaminants in the matrix being evaluated.

The foregoing and other features and advantages of the invention will become further apparent from the following detailed description of the presently preferred embodiments, read in conjunction with the examples and drawings. The detailed description, examples and drawings are merely illustrative rather than limiting, the scope of the invention being defined by the appended claims and equivalents thereof.

### BRIEF DESCRIPTION OF THE DRAWINGS

FIG. 1 is an isometric view of the concentration module of the invention;

FIG. 2 is a diagram of the major components of the concentration module of the invention;

FIG. 3 shows a concentration columns data; and

FIG. 4 is a diagram illustrating the method of the invention employing a concentration module for sampling and concentrating contaminants of a matrix being used at the site where that matrix is being used.

### DETAILED DESCRIPTION OF THE PRESENTLY PREFERRED EMBODIMENTS

While the embodiments disclosed herein are presently considered to be preferred, various modifications and improvements can be made without departing from the spirit and scope of the invention. The scope of the invention is indicated by the appended claims, and all changes that fall within the meaning and range of equivalents are intended to be embraced therein.

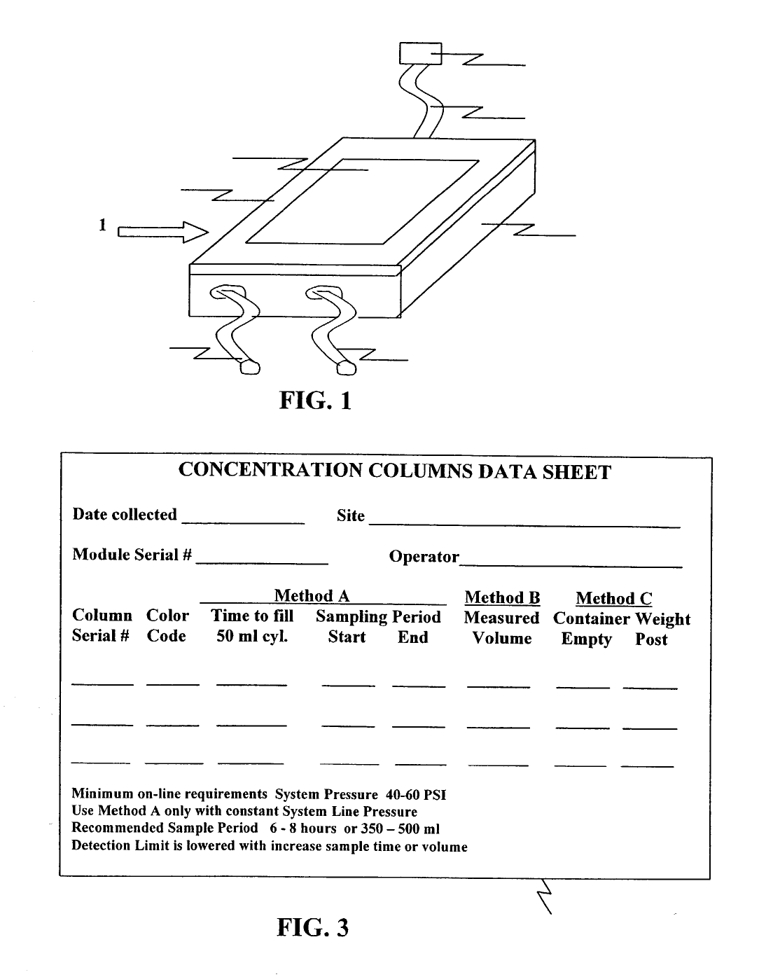

FIG. 1 shows the concentration module 1 having a housing comprised of a rectangular box 6 connected to cover 2, input tubing 5 terminating in connector 4, two color coded output tubing 7 and 8 and data sheet 3 attached to cover 2. Concentration module 1 is easily transported, weighing approximately 160 grams and having the dimensions of 4.5 inches long, 2.5 inches wide and 1.5 inches deep.

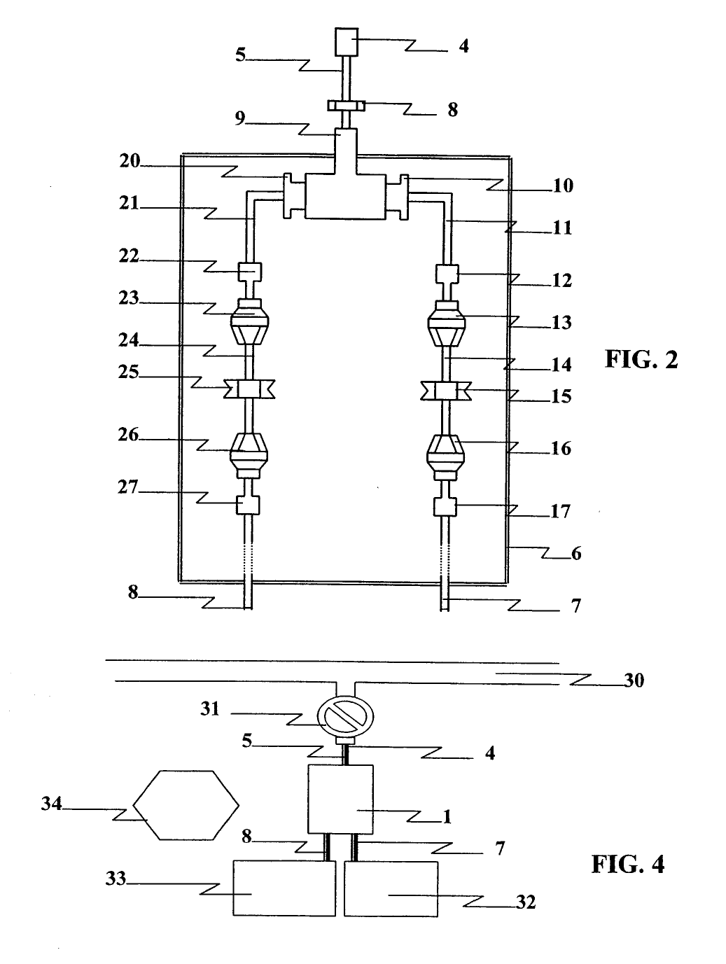

FIG. 2 shows the major components of concentration module 1. A PEEK Tee 9 with through-holes of 0.020 inches (for example, Upchurch Scientific part number P.712) is mounted inside concentration module 1 with the input leg of Tee 9 extending through box 6 of concentration module 1. One end of input tubing 5 is connected to the inlet leg of Tee 9 by nut 8. The other end of input tubing 5 is connected to connector 4 where connector 4 is of the type needed to connect to the source of the matrix to be samples at the site where the matrix is being used. One such connect 4 is a ¼″ NPT female connector. Tee 9 divides the input stream of the matrix into two streams. Where the matrix is ultra pure water, a first stream of ultra pure water will be used to concentrate anions and the second stream of ultra pure water will be used to concentrate cations.

The first stream is carried through a three-inch length of FEP Teflon tubing 11 having a 0.020-inch inner diameter passage and 1/16 inch outer diameter (for example Upchurch Scientific part number 1548). Tubing 11 is attached to the right output leg of Tee 9 by a flangeless fitting 10 (Upchurch Scientific part number P.235/P.200). The other end of tubing 11 is connected to a 10/32 PEEK Nut and PEEK Ferrule 12. Nut and Ferrule 12 is connected to a flangeless end-fitting 13 of a PEEK-Lined metal-free 4.6×50 mm (Alltech part number 66144) concentrated column 14.

The bottom part of the concentrated column 14 is connected to a flangeless end fitting 16. End fittings 13 and 16 and concentration column 14 form a single unit that is detachably mounted within box 6 by clip 15 connected to box 6. A five foot length of FEP Teflon output tubing 7 having an 0.020 inch inner diameter and 1/16 outer diameter (Upchurch Scientific part number 1548) is attached to flangeless end fitting 16 of concentrated column 14 with the 10/32 PEEK Nut and PEEK Ferrule 17. Output tubing 7 is coiled within concentration module 1 and approximately one inch of output tubing 7 extends through box 6 at the bottom of concentration module 1. Output tubing 7 can be pulled out for a desirable length and can be retracted after the sampling is completed. Output tubing 7 is color-coded red to identify output tubing 7 as the output tubing for concentration column 14.

Concentration column 14 is packed with material that will remove the desired contaminant from the matrix. Where the matrix is ultra pure water, anions concentrate column 14 is packed with a resin consisting of a styrene divinyl benzene copolymer agglomerated with a quaternary amine functionalized latex (Dion-ex part number SL 5501). A Standard Slurry Packer (Alltech part number 1666) with 20-ml reservoir capacity is used to pack 25 grams of the resin suspended into 100 ml of ultra pure water at a packing pressure of 2100 psi for three minutes into the anions concentration column 14. These packing conditions provided an anion concentration column 14 with a back pressure of 40 psi and a through flow rate of 1 ml/min for an ultra pure water input pressure 60 psi to the concentration module 1. After packing is completed, the proper effluent is back washed through the anion concentration column 14 to remove any anions held by the packing material, thereby readying the anion concentration column 14 for use.

The second stream is carried through a three-inch length of FEP Teflon tubing 21 having a 0.020 -inch inner diameter passage and 1/16 inch outer diameter (Upchurch Scientific part number 1548). Tubing 21 is attached to the right output leg of Tee 9 by a flangeless fitting 10(Upchurch Scientific part number P.235/P.200). The other end of tubing 21 is connected to a 10/32 PEEK Nut and PEEK Ferrule 22. Nut and Ferrule 22 is connected to a flangeless end fitting 23 of a PEEK-Lined metal-free 4.6×50 mm (Alltech part number 66144) concentrated column 24. The bottom part of the concentrated column 24 is connected to a flangeless end fitting 26. End fitting 23 and 26 and concentration column 24 form a single unit that is detachably mounted within box 6 by clip 25 connected to box 6. A five foot length of FEP Teflon output tubing 8 having an 0.020 inch inner diameter and 1/16 outer diameter (Upchurch Scientific part number 1548) is attached to flangeless end fitting 26 of concentrated column 24 with the 10/32 PEEK Nut and PEEK Ferrule 27. Output tubing 8 is coiled within concentration module 1 and approximately one inch of output tubing 8 extends through box 6 at the bottom of concentration module 1. Output tubing 8 can be pulled out, for a desirable length and can be retracted after the sampling is completed. Output tubing 8 is color-coded green to identify output tubing 8 as the output tubing for concentration column 24.

Concentration column 24 is packed with material that will remove the desired contaminant from the matrix. Where the matrix is ultra pure water, cations concentrate column 24 is packed with a resin consisting of a styrene-divinyl benzene copolymer that is grafted to yield a resin with carboxylate functional groups (Dionex part number SL 5502). A Standard Slurry Packer (Alltech part number 1666) with 20-ml reservoir capacity is used to pack 25 grams of the resin suspended into 100 ml of ultra pure water at a packing pressure of 2500 psi for three minutes into the cation concentration column 24. These packing condition provided a cation concentration column 24 with a back pressure of 50 psi and a through flow rate of 1 ml/min for an ultra pure water input pressure 60 psi to the concentration module 1. After packing is completed, the proper effluent is back washed through the cation concentration column 24 to remove any cations held by the packing material, thereby readying the cation concentration column 24 for use.

While the concentration module 1 has been described as having 30 concentration columns for capturing anions and cations from ultra pure water, a concentration column can be adapted to concentrate or retain the analytes of interest by changing the material in the concentration column.

The material may perform the function of adsorption, absorption, partition, ion exchange, chelation or other reversible mechanism. Depending on the application and nature of the sample the polymeric material varies. For example, to concentrate ionic species appropriate ion exchange material is used. For metallic contaminants, either cation ion exchange, or chelation, or both in varying proportions can be used and for organic compounds carbon or polymeric adsorbent particles are used.

While the concentration module 1 has been described as containing two concentration columns 14 and 24, the concentration module 1 may contain as many concentration columns needed to concentrate the trace contaminants or analytes that are desired to be obtained from the matrix being investigated.

Referring to FIG. 3, a Concentration Column Data Sheet 3 is shown for tracing concentration columns and concentration modules and for recording data for determining the volume of the matrix that was sampled. The provider of a concentration module will record on the Concentration Column Data Sheet 3 the serial number of the concentration module. Also recorded for every concentration column being used within that concentration module is the serial number for that concentration column and the color of the output tubing connected to that concentration column. The serial number of the concentration column identifies what type of contaminants that concentration column will capture. Also recorded are the site, the date when the sampling was done and the operator who took the sample.

Three methods are shown for determining the volume of the matrix sampled. Method A is to be used only when the system pressure for the matrix which is to be sampled is at a constant value between 40 to 60 pounds per square inch. First, the time of starting the sampling is recorded. Second, the time that is necessary to fill a 50 ml cylinder for each concentration column is recorded. This must be done for each concentration columns since each concentration column may have a different flow rate for an input line pressure of the matrix. Finally the time that sampling is ended is recorded. It is recommended that the time be between 6 to 8 hours. A longer time may be used to further lower the detection limits for the contaminants being investigated. The sample volume will be the length of the sample period divided by the length of time necessary to fill the 50 ml cylinder times 50 ml.

Method B employs a properly graduated cylinder to measure the volume of the matrix that has flowed through each of the concentration columns. Another approach is to continue to sample until a desired volume of the matrix has flown through the concentration columns into the graduated cylinders. It is recommended that the sample volume be between 350 ml and 500 ml. A larger volume may be used to further lower the detection limits for the contaminants being investigated.

Method C requires the recording of the weight of each empty container into which the sampled matrix will flow into from an output tube of the concentration module. After sampling is completed, the weight of each container is again recorded. The difference in weight is a measure of the volume of the sampled matrix. For example, one gram of water is equal to one ml of water. It is recommended that the sample volume be between 350 ml and 500 ml. A larger volume may be used to further lower the detection limits for the contaminants being investigated.

Referring to FIGS. 3 and 4, the method of obtaining concentrated contaminants from a matrix will be described. The matrix is flowing through piping 30 at the site where the matrix is being used. A valve 31 is provided at the site for allowing access to the matrix flowing through piping 30. The first step is for the provider of the concentration module 1 to record the data concerning the concentration module 1 onto the Concentration Column Data Sheet 3. The concentration module 1 is then transported to the site where the sampling is to take place. Concentration module 1 is connected to value 31 by connector 4 and tubing 5. Valve 31 is then opened allowing the matrix flowing in pipe 30 to flow through concentration module 1. The concentration columns within concentration module 1 removes the desired contaminants from the sample matrix and the sample matrix exits the concentration module 1 via output tubing 7 and 8 into vessels 32 and 33 respectively. Vessels 32 and 33 are the 50 ml graduate cylinders of Method A, the graduated cylinders of Method B or the containers of Method C. A timer 34 is used to measure the time necessary to fill the 50 ml cylinders of Method A. The relevant volume data is recorded on the Concentration Column Data Sheet 3 for each concentration column. Also recorded on Concentration Column Data Sheet 3 are the collection data, the collection site and the operator who took the sample. The concentration module 1 is then disconnected from valve 31 and transported to the location of the analytical equipment that will determined the type and a quantity of contaminants in each of the concentration columns within concentration module 1. Each concentration column is then connected to the analytical equipment for analysis. The quantity of each identified contaminant contained in a concentration column is then adjusted by the sample volume for that concentration column, thereby lowering the detection limits for the detected contaminants.

While the invention has been particularly shown and described with references to the preferred embodiments thereof, it will be understood by those skilled in the art that changes in form and detail may be made therein without departing from the spirit and scope of the invention. Given the above disclosure of general concepts and specific embodiments, the scope of the protection sought is defined by the following claims.

What is claimed is:

1. A method for concentrating trace contaminants from a matrix for analytical analysis and for minimizing the risk of contamination of said concentrated trace contaminants, the method comprising the steps of:
a) transporting a concentration column to a site where said matrix is being used, said sample concentration column being packed with a functional polymer to capture one or more said trace contaminants from said matrix;
b) connecting said sample concentration column to a site source of said matrix; and
c) passing a sample volume of said matrix through said sample concentration column where said sample volume is greater than a calibration volume of a calibration matrix used to calibrate an analytical instrument for said trace contaminants in said matrix.

2. The method of claim 1 further comprising the steps of:
a) disconnecting said sample concentration column from said site source of said matrix;
b) transporting said sample concentration column to said analytical instrument;
c) processing said sample concentration column by said analytical instrument to identify and obtain a resultant concentration for each detected trace contaminant; and
d) adjusting said resultant concentration for each said detected trace contaminant by dividing said resultant concentration by a factor equal to said sample volume divided by said calibration volume to obtain an actual concentration of each said detected trace contaminant

3. A concentration module for concentrating trace contaminants in a matrix at a site where and while the matrix is being used, said concentration module comprising:
a) a plurality of concentration columns where each said concentration column is packed with the appropriate functional polymer for capturing the desired contaminants;
b) a connector for connecting said concentration module to a site source of said matrix;
c) a distributor connecting said connector to an input side of each said concentration column of said plurality of concentration columns;
d) a plurality of output tubing, each output tubing being connected to an output side of a different said concentration column of said plurality of concentration columns;
e) a housing for enclosing and supporting each said concentration column, the distributor and each said output tubing of said plurality of output tubing where said distributor partial extends out of said housing through a first wall of said housing and where and each said output tubing of said plurality of output tubing partial extends out of said housing through a second wall of said housing.

4. The concentration module of claim 3 wherein said portion of each of said output tubing extending out of said housing is identified by a unique markings.

5. The concentration module of claim 3 wherein said distributor comprises;
a) a tee having one input leg extending out of said housing and a plurality of output legs:
b) input tubing connecting said connector to said input leg of said tee;
c) a plurality of tubes, one end of each tube of said plurality of tubes connected to a said output leg of said tee and a second end of each said tube connected to a concentration column connector for connecting to a said concentration column of said plurality of concentration columns.

6. The concentration module of claim 3 wherein at least one said concentration column of said plurality of said concentration columns is detachable mounted in said housing and detachable from said distributor and said output tubing connected to said concentration column.

7. A concentration module for concentrating trace contaminants in a matrix at a site where and while the matrix is being used, said concentration module comprising:
a) a concentration column packed with the appropriate functional polymer for capturing the desired contaminants;
b) a connector for connecting said concentration module to a site source of said matrix;
c) a distributor connecting said connector to an input side of said concentration column;
d) output tubing connected to an output side of said concentration column; and
e) a housing for enclosing and supporting said concentration column, the distributor and said output tubing where said distributor partial extends out of said housing through a first wall of said housing and where said output tubing partial extends out of said housing through a second wall of said housing.

8. The concentration module of claim 7 wherein said distributor comprises;
a) a tee having an input leg partial extending out of said housing and an output leg;
b) input tubing connecting said connector to said input leg of said tee;
c) a tube where one end of said tube is connected to said output leg of said tee and a second end of said tube is connected to a concentration column connector for connecting to said concentration column.

9. The concentration module of claim 7 wherein said concentration column is detachable mounted in said housing and detachable from said distributor and said output tubing connected to said concentration column.
